(19) United States
(12) Patent Application Publication
(10) Pub. No.: US 2016/0157438 A1
(43) Pub. Date: Jun. 9, 2016

(54) METHOD FOR ACCELERATING GROWTH OF PLANTS IN A CONTROLLED ENVIRONMENT

(71) Applicant: ANTECY B.V., Hoevelaken (NL)

(72) Inventors: Gerrit BREM, Wapenveld (NL); Sasa MARINIC, Zeewolde (NL); Paul O'CONNOR, Hoevelaken (NL); Gerrit VAN PUTTEN, Hoevelaken (NL); Timo ROESTENBERG, Deventer (NL)

(21) Appl. No.: 14/415,150

(22) PCT Filed: Jul. 17, 2013
(86) PCT No.: PCT/EP2013/065077

§ 371 Date: Jan. 16, 2015

Related U.S. Application Data
(60) Provisional application No. 61/672,331, filed on Jul. 17, 2012.
(60) Provisional application No. 61/672,333, filed on Jul. 17, 2012.
(60) Provisional application No. 61/809,898, filed on Apr. 9, 2013.

(51) Int. Cl. A01G 7/02

(52) U.S. Cl. CPC A01G 7/02

(57) ABSTRACT

A method is disclosed for accelerating growth of plants in a controlled environment, such as a greenhouse or an algae pond.

The method comprises reversibly adsorbing carbon dioxide from a carbon dioxide containing gas, such as ambient air or a flue gas; desorbing the adsorbed carbon dioxide; and releasing the desorbed carbon dioxide into the controlled environment.

In a preferred embodiment water vapor is also adsorbed from the carbon dioxide containing gas and recovered as liquid water. The liquid water can be used in the plant growing process.

### BACKGROUND OF THE INVENTION

1. Field of the Invention

The invention relates generally to a method for accelerating growth of plants in a controlled environment, and more particularly to a the use of carbon dioxide in such a method.

2. Description of the Related Art

In photosynthesis plants absorb carbon dioxide from the air and, using energy from the visible part of the solar spectrum, react the carbon dioxide with water to form sugars.

In controlled environments, such as greenhouses and algae ponds, it is important to replenish carbon dioxide that is consumed by the plants. This can be done in greenhouses by ventilation, allowing fresh ambient air to enter the greenhouse environment. In algae ponds carbon dioxide can be replenished by bubbling atmospheric air through the water.

The use of ambient air to replenish carbon dioxide in a controlled environment has significant disadvantages. The air may be colder than the desired temperature of the controlled environment, requiring precious heat energy to be used to increase the temperature of the air before it is released into the controlled environment. In addition, at 340 ppm the carbon dioxide content of ambient air is much lower than what has been found to be the optimum for plant growth.

To counter these disadvantages plant growers are increasingly switching to the use of a concentrated form of carbon dioxide, or even pure carbon dioxide. Concentrated forms of carbon dioxide can be obtained, for example, from power plants and refineries. These facilities produce carbon dioxide as part of a gas stream, such as flue gas, that is contaminated with toxic and corrosive gases, such as NOx and SOx. These toxic substances must be removed before the carbon dioxide is suitable for plant growth. Depending on the distance from the carbon dioxide generating facility to the plant growing facility, the cost of transporting carbon dioxide is at best a burden on the environment, and at worst cost prohibitive.

There is a need for a method of accelerating plant growth that can be carried out in the proximity of a plant growing facility.

### BRIEF SUMMARY OF THE INVENTION

The present invention addresses these problems by providing a method of accelerating growth of plants in a controlled environment, said method comprising the steps of:

reversibly adsorbing carbon dioxide onto a solid adsorbent;
desorbing carbon dioxide from the solid adsorbent;
releasing desorbed carbon dioxide into the controlled environment.

Another aspect of the invention comprises a process for harvesting water from a gas, such as ambient air. The harvested water can be used in the plant growing process.

### DETAILED DESCRIPTION OF THE INVENTION

The following is a detailed description of the invention.

The invention relates to a method of growing plants in a controlled environment. The term “controlled environment” as used herein refers to any plant growth environment in which at least one parameter that is important for plant growth is partially or fully controlled by man. Examples of such parameters include atmospheric composition, temperature, light, and water. Greenhouses and algae growing ponds are well known examples of controlled plant growing environments. The invention will be described in detail with reference to greenhouses. It will be understood, however, that the method of the invention can be used in any type of controlled plant growth environment.

In its general aspect, the present invention relates to a method of accelerating growth of plants in a controlled environment, said method comprising the steps of:

reversibly adsorbing carbon dioxide from a carbon dioxide containing gas onto a solid adsorbent;
desorbing carbon dioxide from the solid adsorbent;
releasing desorbed carbon dioxide into the controlled environment.

The carbon dioxide containing gas can, for example, be the flue gas of the heating system of a greenhouse. A greenhouse generally requires more heating during the night, when the outside temperature is lower. However, the carbon dioxide demand of growing plants is reduced at night, when the photosynthesis process is inactive due to lack of light. The method of the invention allows for storage of flue gas carbon dioxide during the night hours, so it can be used for plant growth during the day.

In an alternate embodiment the carbon dioxide containing gas is ambient air. The earth's atmosphere provides a virtually limitless supply of carbon dioxide, which is continuously being replenished by combustion of fossil fuels. The method of the invention allows for harvesting carbon dioxide form ambient air, and using it in a plant growing process in a more concentrated form. Natural air currents ensure continuous equalization of the carbon dioxide concentration on the earth's atmosphere. In a sense, carbon dioxide emitted from a car exhaust in New York City can be used for growing vegetables in Egypt, with the sun providing transportation of the carbon dioxide from New York City to Egypt, free of charge.

The carbon dioxide containing gas generally also contains water vapor. It is often desirable to also reversibly adsorb water vapor, which can be used as a source of liquid water for the plant growing process.

Materials and processes for reversibly adsorbing carbon dioxide are disclosed in our co-pending patent U.S. patent application Ser. No. 61/672331, filed Jul. 17, 2012, from which priority is claimed herein, and the disclosures of which are incorporated herein by reference.

Examples of suitable materials include materials selected from the group consisting of TiO₂; K₂O; MgO; Al₂O₃; ZnO; FeₓO_{y}; BaO; CaO; MnₓO_{y}; CuO; active carbon; and mixtures thereof, wherein x stands for 2 or 3, and y stands for 3, 4, or 7.

In an alternate embodiment the solid adsorbent comprises a porous carrier material having deposited thereon: (i) a salt capable of reacting with carbon dioxide; and optionally (ii) a particulate, water-insoluble inorganic material. The salt can be one that is capable of reacting with carbon dioxide and water to form a bicarbonate. Examples include salts of Li, Na, K, Ca, Ba, and mixtures thereof.

In a preferred embodiment a solid adsorbent is used that is capable of adsorbing carbon dioxide at a first temperature T₁ and of desorbing carbon dioxide at a second temperature T₂, such that T₂>T₁ and ΔT, defined, as T₂ minus T₁ is less than 200° C., preferably less than 160° C.

The adsorption/desorption process can be carried out in a device as disclosed in our co-pending patent U.S. patent application Ser. No. 61/672333, filed Jul. 17, 2012, from which priority is claimed herein, and the disclosures of which are incorporated herein by reference.

Specifically, the adsorption and desorption steps can be carried out in a device for conducting an adsorption/desorption temperature swing process having a desorption step conducted at least in part at a desorption temperature below 100° C., said device comprising (i) a reservoir containing water; (ii) a reactor containing an adsorbent; and (iii) a vacuum source; the reservoir, the reactor and the vacuum source being in fluid connection with each other during the desorption step so that the vacuum source causes water in the reservoir to evaporate, and water vapor to flow through the reactor for purging the adsorbent.

In this device water vapor can also be adsorbed from the carbon dioxide containing gas. This water vapor is desorbed from the solid adsorbent during the purge step, and is condensed together with the water vapor used for purging the solid adsorbent. Thus, the device has a positive water balance. Water recovered from the device can be used in the plant growing process.

The release of desorbed carbon dioxide is preferably controlled to optimize plant growth. It has been found that the optimum carbon dioxide concentration in a greenhouse during daylight hours is in the range of from 350 ppm to 1000 ppm, preferably from 600 ppm to 800 ppm. It has been found also that release of carbon dioxide into a greenhouse is best started between 30 minutes and two hours after sunrise.

Many modifications in addition to those described above may be made to the structures and techniques described herein without departing from the spirit and scope of the invention. Accordingly, although specific embodiments have been described, these are examples only and are not limiting upon the scope of the invention.

What is claimed is:

1. A method of accelerating growth of plants in a controlled environment, said method comprising the steps of:
a. reversibly adsorbing carbon dioxide from a carbon dioxide containing gas onto a solid adsorbent;
b. desorbing carbon dioxide from the solid adsorbent;
c. releasing desorbed carbon dioxide into the controlled environment.

2. The method of claim 1 wherein the controlled environment is a greenhouse or an algae growing pond.

3. The method of claim 1 or 2 wherein step a) is carried out in atmospheric air.

4. The method of any one of the preceding claims comprising the additional step a(1) of reversibly adsorbing water vapor.

5. The method of claim 4 comprising the additional steps of desorbing water vapor from the solid adsorbent and converting the water vapor to liquid water.

6. The method of claim 5 wherein at least part of the liquid water is provided to the plants.

7. The method of any one of the preceding claims wherein the solid adsorbent comprises a material selected from the group consisting of TiO₂; K₂O; MgO; Al₂O₃; ZnO; FeₓO_{y}; BaO; CaO; MnₓO_{y}; CuO; active carbon; and mixtures thereof wherein x stands for 2 or 3 and y stands for 3, 4, or 7.

8. The method of any one of the preceding claims wherein the solid adsorbent comprises a porous carrier material having deposited thereon: (i) a salt capable of reacting with carbon dioxide; and optionally (ii) a particulate, water-insoluble inorganic material.

9. The method of claim 8 wherein the salt is capable of reacting with carbon dioxide and water to form a bicarbonate.

10. The method of claim 8 or 9 wherein the salt capable of reacting with water and carbon dioxide to form a bicarbonate is a salt of Li, Na, K, Ca, Ba, or a mixture thereof.

11. The method of claim 8, 9 or 10 wherein the solid adsorbent is which is capable of adsorbing carbon dioxide at a first temperature T₁ and of desorbing carbon dioxide at a second temperature T₂, such that T₂>T₁ and ΔT, defined, as T₂ minus T₁ is less than 200° C., preferably less than 160° C.

12. The method of any one of the preceding claims wherein steps a) and b) are carried out in a device for conducting an adsorption/desorption temperature swing process having a desorption step conducted at least in part at a desorption temperature below 100° C., said device comprising (i) a reservoir containing water; (ii) a reactor containing an adsorbent; and (iii) a vacuum source; the reservoir, the reactor and the vacuum source being in fluid connection with each other during the desorption step so that the vacuum source causes water in the reservoir to evaporate, and water vapor to flow through the reactor for purging the adsorbent.

13. The method of any one of the preceding claims wherein water vapor is also adsorbed from the carbon dioxide containing gas, and recovered as liquid water.

14. The method of claim 13 wherein the liquid water is used for growing plants in the controlled environment.
